(19) United States
(12) Patent Application Publication
(10) Pub. No.: US 2014/0287232 A1
(43) Pub. Date: Sep. 25, 2014

(54) HIGHLY CRYSTALLIZED PARTICLES AND PRODUCTION METHOD THEREOF

(71) Applicant: Kabushiki Kaisha Toshiba, Minato-ku (JP)

(72) Inventors: Yoko TOKUNO, Tokyo (JP); Tomomichi NAKA, Chigasaki-shi (JP); Yuji NAGASHIMA, Fujisawa-shi (JP)

(73) Assignee: Kabushiki Kaisha Toshiba, Minato-ku (JP)

(21) Appl. No.: 14/023,629

(22) Filed: Sep. 11, 2013

(30) Foreign Application Priority Data
Mar. 21, 2013 (JP) 2013-059008

(51) Int. Cl. C01G 41/02; B01D 9/00

(52) U.S. Cl. CPC C01G 41/02; B01D 9/00
USPC 428/402; 205/766; 423/606

(57) ABSTRACT

According to one embodiment, there is provided a method for producing highly crystallized particles having a specific surface area of 5 m²/g or more. The raw material composition contains a resin and at least partially amorphous precursor particles. The composition is heat-treated to carbonize the resin and improve the crystallinity of the precursor particles. A mixture of highly crystallized particles and carbon is prepared. Then, a solution containing an acid is contacted with the mixture to react the acid with the carbon. The carbon is removed and a slurry containing reaction product is prepared. The highly crystallized particles include a first portion having a smaller diameter and a second portion having a larger diameter.

### CROSS-REFERENCE TO RELATED APPLICATIONS

This application is based upon and claims the benefit of priority from Japanese Patent Application No. 2013-059008, filed Mar. 21, 2013, the entire contents of which are incorporated herein by reference.

### FIELD

Embodiments described herein relate generally to highly crystallized particles and a production method thereof.

### BACKGROUND

Particles having a small particle diameter have a large specific surface area and they may exert a high performance even in a small amount thereof. Accordingly, such particles have long been used in a wider variety of fields.

In many cases, if the crystallinity of the particles is improved, the performance is significantly improved. Such highly crystallized particles are obtained by, for example, the following method.

First, precursor particles having relatively low crystallinity are coated with carbon. Then, the precursor particles coated with carbon are heated to a temperature higher than the crystallization temperature in an atmosphere with a low concentration of oxygen to improve the crystallinity of the particles. Thereafter, the carbon is oxidized by heat treatment in an oxygen containing atmosphere.

In the method, the carbon coating plays a role in limiting the grain growth to a region surrounded by the carbon coating. Therefore, as particles having a small particle diameter as the precursor particles are used, it is possible to obtain highly crystallized particles having a small particle diameter. Further, in the method, the oxidized carbon is removed from the highly crystallized particles as a carbon dioxide gas. Thus, it is easy to produce highly crystallized particles.

### BRIEF DESCRIPTION OF THE DRAWINGS

FIG. 1 is a graph showing an example of the influence of the calcination temperature and the calcination time on the crystallinity of particles;

FIG. 2 is a graph showing an example of the influence of the pH of a treatment solution on the recovery rate of highly crystallized particles;

FIG. 3 is a scanning electron microscope (SEM) photograph of highly crystallized particles having a large diameter;

FIG. 4 is an SEM photograph of precursor particles;

FIG. 5 is an SEM photograph of highly crystallized particles after removal of carbon by oxidation;

FIG. 6 is a graph showing X-ray diffraction spectra obtained by subjecting highly crystallized particles to X-ray diffraction (XRD); and

FIG. 7 is an SEM photograph of highly crystallized particles after removal of carbon by oxidation in a gas phase.

### DETAILED DESCRIPTION

A method for producing highly crystallized particles according to the embodiments is a method for producing highly crystallized particles having a specific surface area of 5 m²/g or more. The method includes heat-treating a raw material composition that contains a resin and at least partially amorphous precursor particles dispersed in the resin to carbonize the resin and improve the crystallinity of the precursor particles and preparing a mixture of highly crystallized particles and carbon, and bringing a treatment solution containing an acid into contact with the mixture to react the acid with the carbon and preparing a slurry containing the highly crystallized particles from which the carbon is removed. The highly crystallized particles include a first portion having a smaller particle diameter and a second portion having a larger particle diameter and a product generated by the reaction remain in the slurry.

Hereinafter, the method for producing highly crystallized particles according to the embodiments will be described.

(Preparation of Raw Material Composition)

First, a raw material composition of highly crystallized particles is prepared.

The raw material composition includes a resin and precursor particles of the highly crystallized particles. The precursor particles and the resin are uniformly mixed together in the raw material composition,

Typically, the precursor particles are comprised of an inorganic substance such as a metal compound. Examples of the inorganic substance to be used for the precursor particles include tungsten oxide (WO₃). It has conventionally been difficult to obtain highly crystallized particles having a small average particle diameter from the precursor particles comprised of a material having a low crystallization temperature like WO₃. However, according to a technique described herein, highly crystallized particles having a small average particle diameter can be easily obtained from the precursor particles.

Typically, the precursor particles have the same or almost the same composition as that of the highly crystallized particles. The crystallinity of the precursor particles is lower than that of the highly crystallized particles. Therefore, the precursor particles are at least partially amorphous.

Typically, the average particle diameter of the precursor particles is almost equal to that of the highly crystallized particles. The average particle diameter of the precursor particles is, for example, from 3 to 20 nm. However, if the highly crystallized particles are allowed to grow after removal of the carbon coating, the average particle diameter of the precursor particles becomes lower than that of the highly crystallized particles. Further, if coarse particles are removed from the highly crystallized particles after removal of the carbon coating, the average particle diameter of the precursor particles becomes lager than that of the highly crystallized particles.

The average particle diameters of the precursor particles and the highly crystallized particles are obtained by the following method. First, the precursor particles or the highly crystallized particles are photographed using SEM. Then, the particles whose whole image can be seen are selected from the particles in SEM photograph thus obtained and their areas are measured. Assuming that each of the selected particles is in spherical form, the diameters of the particles are calculated from the measured areas and an average of these diameters is defined as an average particle diameter.

As the resin to be used for the raw material composition, there is selected a resin which is carbonized when it is heated in an atmosphere with a low concentration of oxygen, typically, in an inert gas atmosphere. In other words, there is selected a resin in which elements other than carbon form gas molecules when it is thermally decomposed like ethyl cellulose.

A paste-like raw material composition is obtained by dispersing the precursor particles and the resin in, for example, a solvent containing a dispersant and stirring and mixing the mixture. The form of the raw material composition is not limited to the paste. For example, the raw material composition may be a slurry or a solid obtained by drying a paste or a slurry.

(Carbonization and High Crystallization)

Subsequently, a raw material composition is heat-treated in an atmosphere with a low concentration of oxygen to carbonize the resin and improve the crystallinity of precursor particles. Thus, a mixture of highly crystallized particles and carbon is obtained. The precursor particles are coated with carbon by the carbonization of the resin. For example, a structure in which the precursor particles are dispersed in a matrix formed of carbon or a structure in which the precursor particles are covered with a covering layer formed of carbon is obtained. In such a structure, the grain growth in the precursor particles may be promoted. However, the growth is limited to a region surrounded by the carbon coating, i.e., a region surrounded by the interface between the carbon coating and the highly crystallized particles. Therefore, highly crystallized particles having a particle diameter almost equal to that of the precursor particles are obtained.

The heat treatment for carbonizing the resin is performed, for example, in an atmosphere having an oxygen content of 10% by volume or less so that the carbon generated from the resin in the raw material composition remains in the raw material composition. Typically, the heat treatment is performed in an inert gas atmosphere.

The heat treatment for high crystallization needs to be performed at a temperature higher than the crystallization temperature of the precursor particles. When the precursor particles are comprised of WO₃, the temperature of the heat treatment for high crystallization is, for example, 500° C. or more.

The carbonization may be performed almost simultaneously with the high crystallization or the high crystallization may be performed after the carbonization. In the former case, the heat treatment may be performed at a temperature in which both the carbonization and the high crystallization can proceed. In the latter case, the material is selected so that the crystallization temperature of precursor particles is higher than the minimum temperature carbonizing the resin, the heat treatment for carbonization is performed at a temperature lower than the crystallization temperature of precursor particles for a sufficient time, and the heat treatment for high crystallization is performed at a temperature higher than the crystallization temperature for a sufficient time.

In this regard, many resins can be carbonized at a temperature at which the crystal grain of the material constituting the precursor particles hardly grows. Therefore, when high crystallization is performed after carbonization, if the grain growth of the material constituting the precursor particles can be sufficiently suppressed, the heat treatment for carbonization at a temperature lower than the crystallization temperature of the precursor particles is not necessarily performed.

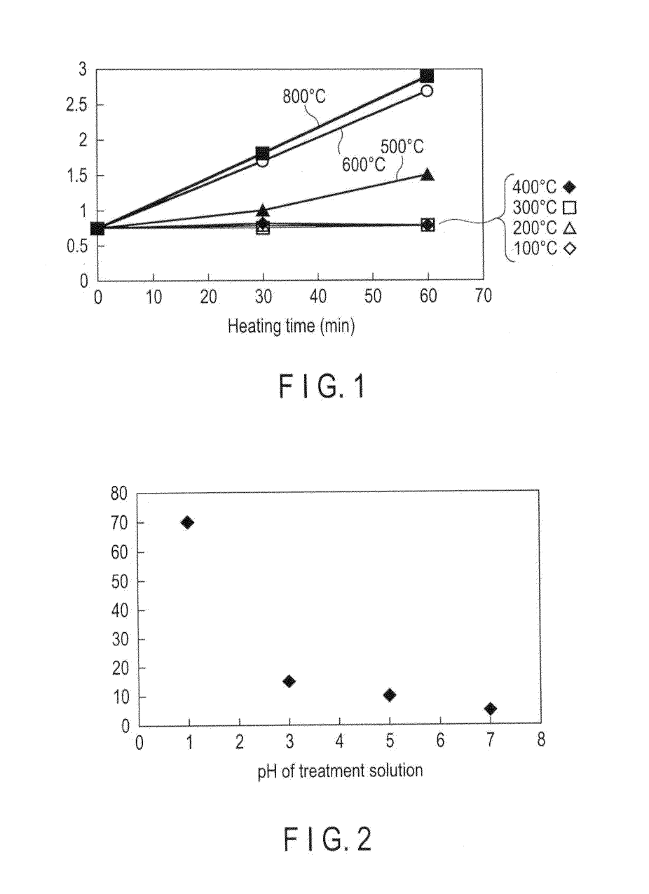

FIG. 1 shows an example of the influence of the heating temperature and the heating time on the crystallinity of precursor particles comprised of WO₃. In FIG. 1, a horizontal axis indicates the heating time, and a vertical axis indicates the crystallinity of particles. In this regard, the crystallinity is obtained by quantifying and using a ratio of the intensity at a diffraction angle 2θ of 24.38° to the intensity at a diffraction angle 2θ of 23.92° obtained by XRD measurement.

As shown in FIG. 1, when the heating temperature is 400° C. or less, the crystallinity of the precursor particles is not improved regardless of the heating time. If the heating temperature is set to 500° C., the crystallinity of the precursor particles is improved. However, the progress is very slow. When the heating temperature is set to 600° C. or more, the crystallinity of the precursor particles can be improved at a sufficiently rapid rate.

Therefore, for example, when a raw material composition is heat-treated in a nitrogen atmosphere at 500° C. for 30 minutes and then the raw material composition is further heat-treated in a nitrogen atmosphere at 800° C. for 30 minutes, the resin can be immediately carbonized substantially without the growth of WO₃ crystal grains and the crystallinity of the precursor particles of WO₃ can be improved at a sufficiently rapid rate.

(Removal of Carbon Coating)

The highly crystallized particles obtained by the above method are coated with carbon. The carbon coating can be removed by oxidation by heat treatment in an oxygen containing atmosphere. However, when the highly crystallized particles are comprised of a material which generates grain growth at a relatively low temperature, if the gas phase oxidation is used to remove the carbon coating, grain growth is promoted. Thus, the particle diameter of the highly crystallized particles is increased.

Then, in this embodiment, the carbon coating is removed by reacting with an acid. Specifically, a treatment solution containing an acid is prepared and the treatment solution is brought into contact with a mixture of highly crystallized particles and carbon coating. For example, the mixture is pulverized, if necessary, and the pulverized powder is dispersed in the treatment solution. Then, the carbon coating is sufficiently reacted with an acid.

In reacting the carbon with an acid, the treatment solution may be heated. When the heating is performed at a temperature higher than the boiling point of the acid, the treatment solution may be heated under reflux to react the acid with the carbon.

Any acid may be used as long as it can remove carbon from highly crystallized particles. The acid may be an inorganic acid or an organic acid. As a typical acid, one playing a role of an oxidant is used. Examples of the acid include nitric and sulfuric acids. In this regard, an acid having a low boiling point (e.g., nitric acid) can be at least partially removed by heating the treatment solution after removal of the carbon from the highly crystallized particles.

The treatment solution may further contain a liquid medium such as water, in addition to the acid. However, the pH value of a treatment solution is preferably 1 or less.

FIG. 2 shows an example of the influence of the pH value of the treatment solution on the recovery rate of highly crystallized particles. In FIG. 2, a horizontal axis indicates the pH value of the treatment solution and a vertical axis indicates the recovery rate of the particles.

The data shown in FIG. 2 was obtained when a nitric acid solution was used as the treatment solution to remove the carbon from the WO₃ particles coated with carbon. Here, the WO₃ particles coated with carbon and the nitric acid solution were introduced into a reaction vessel to which a reflux condenser was attached, followed by heating the mixture for reaction at 180° C. for 5 hours. The solution after the reaction was subjected to centrifugation to separate it into a supernatant and a precipitate. The recovery rate of highly crystallized particles was calculated based on the precipitate.

As shown in FIG. 2, if the pH value of the treatment solution is set to 1 or less, the recovery rate of highly crystallized particles is improved. This is because when the pH value of the treatment solution is low, the highly crystallized particles easily aggregate and thus a large amount of the highly crystallized particles is contained in a precipitation layer in the treatment solution.

(Purification)

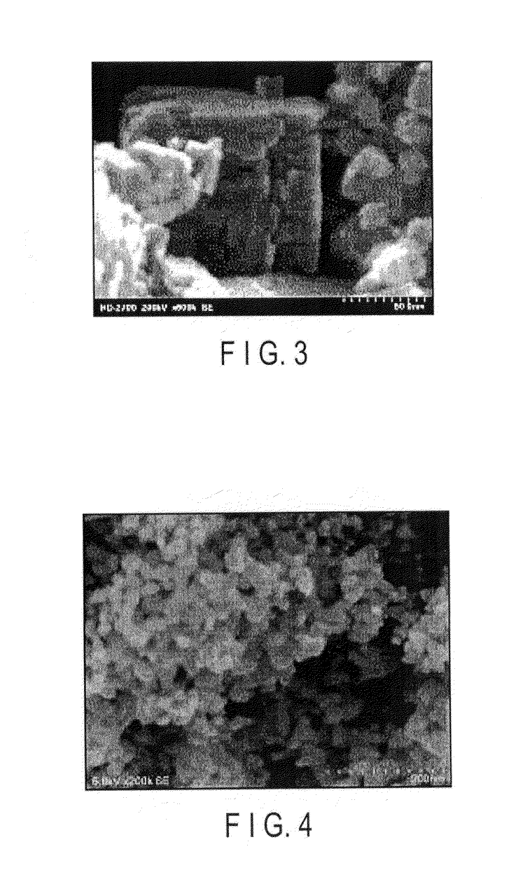

The slurry obtained by the above treatment contains the highly crystallized particles from which the carbon has been removed. The slurry may contain coarse particles as some of the highly crystallized particles. For example, highly crystallized particles having a particle diameter in the order of 100 nm as shown in FIG. 3 are contained in the slurry. When such coarse particles need to be removed, or when highly crystallized particles having a smaller average particle diameter need to be obtained, the following purification is used to perform purification.

First, the slurry is subjected to centrifugation to separate it into a supernatant and a precipitate. The supernatant may include highly crystallized particles having a particle diameter smaller than that of the highly crystallized particles contained in the precipitate. Further, the precipitate may have a multilayer structure which includes a layer having a larger specific gravity and a layer having a smaller specific gravity. Here, as an example, it is assumed that the slurry is separated into a precipitate having a two-layer structure of a layer having a larger specific gravity and a layer having a smaller specific gravity and a supernatant containing highly crystallized particles having a small particle diameter by centrifugation. It is assumed that the layer having a larger specific gravity and the layer having a smaller specific gravity differ in color.

When nitric acid is used as the acid, the layer having a larger specific gravity may appear whitish in color, and the layer having a smaller specific gravity may appear bluish in color. In this case, the supernatant may be seen as dark brown.

Next, at least a part of the precipitate is removed from the slurry separated into the supernatant and the precipitate. For example, a layer having a larger specific gravity or two layers including a layer having a larger specific gravity and a layer having a smaller specific gravity is removed. Thus, highly crystallized particles having a large particle diameter are removed from the slurry.

Thereafter, the slurry is subjected to electrolysis, if necessary. Thus, an acid remaining in the slurry and a product which is generated by the reaction for removing carbon and remains in the slurry are removed.

Further, the slurry includes, typically, an acid which is not consumed by the reaction with carbon and a product generated by the reaction. When these substances need to be removed, the slurry is subjected to the following electrolysis.

In order to improve the conductivity, an acid is added to the slurry to adjust the pH value to around 1.5, if necessary. An improvement in the conductivity may cause precipitation of some of the disperse particles.

Next, the slurry is subjected to electrolysis. In the electrolysis, for example, platinum electrodes are used as positive and negative electrodes. When nitric acid is used as the acid, nitrogen oxide (NO_{X}) remains in the slurry. If the slurry is subjected to the electrolysis, the NO_{X} in the slurry is converted to nitrogen molecules (N₂) or nitrate ions (NO₃⁻). The NO_{X} is removed from the slurry in the above manner.

In this regard, both N₂ and NO₃⁻ in the slurry can be removed by, for example, heating the slurry.

(Drying)

When the highly crystallized particles are used in the form of fine particles, the above slurry is dried. For example, the slurry is dried under reduced pressure, or the slurry is frozen and dried under reduced pressure. Prior to the drying step, the above slurry may be subjected to centrifugation to remove at least a part of the supernatant.

For example, when evaporative removal of a dispersion medium is performed on a heated hot plate instead of freezing and reduced pressure drying of the slurry, the aggregation of highly crystallized particles may be caused. Therefore, when the dispersion is dried by heating, for example, it is difficult to disperse the produced highly crystallized particles into a paste for use. When it is not necessary to use the highly crystallized particles in powder form, the colorless dispersion does not need to be frozen in drying under reduced pressure.

According to the above method, even in the case of the material which generates grain growth at a relatively low temperature, it is possible to produce highly crystallized particles having a small particle diameter, specifically highly crystallized particles having a specific surface area of 5 m²/g or more.

In this regard, when the XRD measurement is performed on the highly crystallized particles of WO₃ produced by the above method, a ratio of the intensity at a diffraction angle 2θ of 24.38° to the intensity I_{23.92}° at a diffraction angle 2θ of 23.92° (I_{24.38}°/I_{23.92}°) is typically 2 or more.

### EXAMPLES

### Example 1

(Preparation of Raw Material Composition)

A slurry obtained by stirring and mixing 5.0 parts by mass of WO₃ powder (specific surface area: 100 m²/g), 10.0 parts by mass of ethyl cellulose, 2.5 parts by mass of a dispersant, 61.9 parts by mass of butyl carbitol acetate, and 20.6 parts by mass of α-terpineol was prepared. FIG. 4 is an SEM photograph of the WO₃ powder used herein.

(High Crystallization)

A raw material composition was heat-treated in a muffle furnace in a nitrogen atmosphere at 500° C. for 30 minutes. As a result, ethyl cellulose present around WO₃ particles was converted to amorphous carbon. Subsequently, the resulting product was further heat-treated in a nitrogen atmosphere at 800° C. for 30 minutes. Thus, the crystallinity of the WO₃ particles was improved. A black powder comprised of WO₃ particles and carbon coating was obtained in the above manner.

(Removal of Carbon Coating)

The obtained black powder was dispersed in a nitric acid solution containing nitric acid at a concentration of 96% by mass to prepare a slurry. The slurry was subjected to heat treatment under reflux at 180° C. for 5 hours and the nitric acid gas was released from the system.

(Purification)

Thereafter, the slurry was subjected to centrifugation to separate it into a dark brown supernatant and a precipitate. In this regard, the coloring of the supernatant results from the NO_{X} remaining in the slurry.

The supernatant was separated from the precipitate. Hydrochloric acid was added thereto so as to have a pH value of 1. A dark-brown precipitate was formed by the addition of hydrochloric acid. Thereafter, the solution was subjected to electrolysis. Here, platinum electrodes were used as positive and negative electrodes. At 1.5 hours after the start of electrolysis, the color of the precipitate changed from dark brown to blue, while the color of the supernatant changed to pale brown. At 6 hours after the start of electrolysis, the supernatant became colorless.

(Drying)

Subsequently, the slurry containing the blue precipitate and the colorless supernatant was placed in a freeze dryer. Then, the slurry was frozen at −20° C. Subsequently, water was removed while decompressing the inside of the freeze dryer up to 20 Pa and supplying the heat required for evaporation of water. Thus, WO₃ particles as highly crystallized particles were obtained in powder form.

(Measurement of Average Particle Diameter)

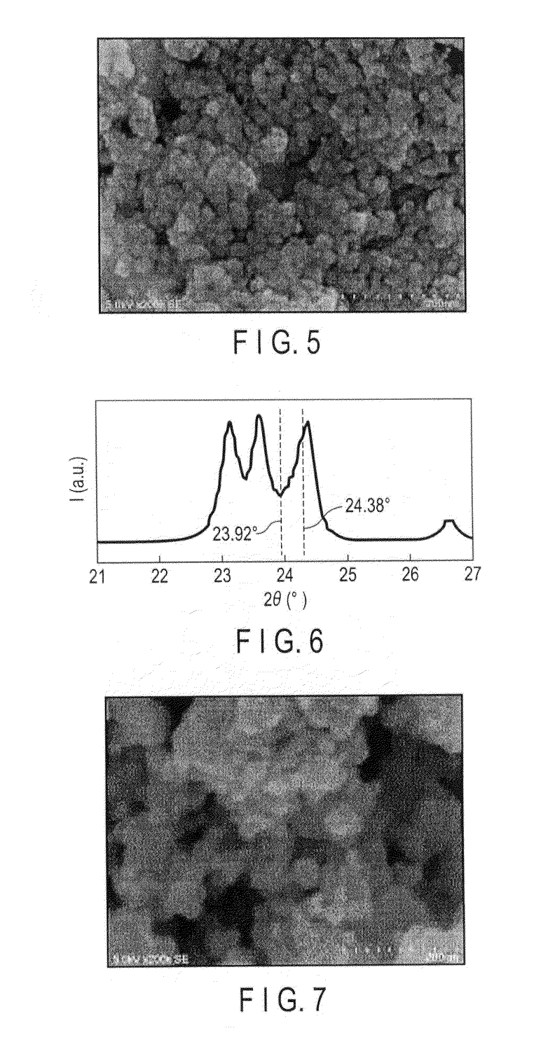

The average particle diameter of the obtained WO₃ particles was measured by observation using SEM. The SEM photograph used in the measurement is shown in FIG. 5.

As is clear from FIGS. 4 and 5, the grain growth of the WO₃ particles could be prevented in this example. Further, the highly crystallized particles maintained the shape of precursor particles.

(Measurement of Specific Surface Area)

The specific surface area of the obtained WO₃ particles was measured by gas-phase-adsorption. Specifically, an analyzer (Macsorb (registered trademark) HM Model-1200, manufactured by Mountech) and the BET method were used to measure the specific surface area of the WO₃ particles. The specific surface area of the obtained WO₃ particles was 60 m²/g.

(Evaluation of Crystallinity)

The crystallinity of the obtained WO₃ particles was evaluated by XRD measurement. The results of XRD measurement are shown in FIG. 6.

As shown in FIG. 6, three peaks of X-ray intensity were present at an X-ray diffraction angle 2θ (22° or more and less than 25°). From this result, it was confirmed that three crystal systems (monoclinic, orthorhombic, and triclinic systems) coexsisted in WO₃ particles as highly crystallized particles. As an indicator of crystallinity, an intensity ratio of the peak of the diffraction angle 2θ at 24.38° to the bottom of the diffraction angle 2θ at 23.92° (I_{24.38}°/I_{23.92}°) was determined, and the value was 2.57.

### Example 2

As highly crystallized particles, WO₃ particles in powder form were obtained in the same manner as described in Example 1 except that the amount of ethyl cellulose was set to 15.0 parts by mass, the amount of butyl carbitol acetate was set to 58.1 parts by mass, and the amount of α-terpineol was set to 19.4 parts by mass in the raw material composition. Regarding the specific surface area and crystallinity of the highly crystallized particles obtained in Example 2, the same results as Example 1 were obtained.

### Comparative Example

As highly crystallized particles, WO₃ particles in powder form were obtained in the same manner as described in Example 1 except that carbon was removed by using heat treatment in an oxygen containing atmosphere in place of nitric acid. The SEM photograph of the highly crystallized particles obtained in this comparative example is shown in FIG. 7.

The highly crystallized particles of WO₃ obtained in the comparative example were subjected to crystallinity evaluation and specific surface-area measurement in the same manner as described in Example 1. As for the specific surface area of the highly crystallized particles of WO₃ obtained in the comparative example, the specific surface area was 100 m²/g before heat treatment, and after removal of carbon, it had changed to 20 m²/g. As for the crystallinity, the value of I_{24.38}°/I_{23.92}° was 2.50.

As described above, it was confirmed that the WO₃ particles obtained in Examples 1 and 2 were highly crystallized and that grain growth of the WO₃ particles was prevented. The WO₃ particles obtained in the comparative example were highly crystallized; however, the specific surface area thereof was small. Thus, it was found that the particle diameter increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for producing highly crystallized particles having a specific surface area of 5 m²/g or more, the method comprising:
heat-treating a raw material composition that comprises a resin and at least partially amorphous precursor particles dispersed in the resin to carbonize the resin and improve the crystallinity of the precursor particles, thereby preparing a mixture of highly crystallized particles and carbon; and
bringing a treatment solution comprising an acid into contact with the mixture to react the acid with the carbon and preparing a slurry comprising the highly crystallized particles from which the carbon is removed, the highly crystallized particles comprising a first portion having a smaller particle diameter and a second portion having a larger particle diameter and a product generated by the reaction remaining in the slurry.

2. The method according to claim 1, wherein the treatment solution has a pH of 1 or less.

3. The method according to claim 1, further comprising subjecting the slurry to electrolysis to remove the product.

4. The method according to claim 3, further comprising:
before subjecting the slurry to the electrolysis, subjecting the slurry to centrifugation to separate the slurry into a supernatant in which the first portion of the highly crystallized particles is dispersed and a precipitate comprising the second portion of the highly crystallized particles; and
removing at least a part of the precipitate from the slurry separated into the supernatant and the precipitate, and wherein the slurry from which at least the part of the precipitate is removed is subjected to the electrolysis.

5. The method according to claim 3, further comprising drying the slurry under reduced pressure after subjecting the slurry to electrolysis.

6. The method according to claim 5, further comprising:
before subjecting the slurry to the electrolysis, subjecting the slurry to centrifugation to separate the slurry into a supernatant in which the first portion of the highly crystallized particles is dispersed and a precipitate comprising the second portion of the highly crystallized particles; and
removing at least a part of the precipitate from the slurry separated into the supernatant and the precipitate, and wherein the slurry from which at least the part of the precipitate is removed is subjected to the electrolysis.

7. The method according to claim 3, further comprising:
after subjecting the slurry to electrolysis, freezing the slurry to obtain frozen slurry; and
drying the frozen slurry under reduced pressure.

8. The method according to claim 7, further comprising:
before subjecting the slurry to the electrolysis, subjecting the slurry to centrifugation to separate the slurry into a supernatant in which the first portion of the highly crystallized particles is dispersed and a precipitate comprising the second portion of the highly crystallized particles; and
removing at least a part of the precipitate from the slurry separated into the supernatant and the precipitate, and wherein the slurry from which at least the part of the precipitate is removed is subjected to the electrolysis.

9. The method according to claim 1, wherein the heat-treating is performed at a temperature higher than a crystallization temperature of the precursor particles.

10. The method according to claim 1, wherein the resin is a resin which is carbonized by heat-treating in an inert gas atmosphere.

11. The method according to claim 1, wherein the precursor particles comprise WO₃.

12. The method according to claim 11, wherein the heat-treating is performed at 500° C. or more.

13. The method according to claim 1, wherein the precursor particles have an average particle diameter of 3 to 20 nm.

14. The method according to claim 1, wherein the heat-treating is performed in an atmosphere having an oxygen content of 10% by volume or less.

15. The method according to claim 14, wherein the atmosphere is an inert gas atmosphere.

16. The method according to claim 1, wherein a structure in which the precursor particles are dispersed in a matrix formed of carbon or a structure in which the precursor particles are covered with a covering layer formed of carbon is obtained by the heat-treating.

17. The method according to claim 1, wherein the acid is nitric acid.

18. The method according to claim 1, further comprising pulverizing the mixture before bringing the treatment solution into contact with the mixture.

19. The method according to claim 1, further comprising heating the treatment solution to react the carbon with the acid.

20. Highly crystallized particles having a specific surface area of 5 m²/g or more.
